(19) United States
(12) Patent Application Publication
(10) Pub. No.: US 2006/0191995 A1
(43) Pub. Date: Aug. 31, 2006

(54) Secure transaction system

(75) Inventors: Richard G. Stewart, Canyon Country, CA (US); Richard J. Stewart, North Hills, CA (US)

Correspondence Address: PATTERSON & SHERIDAN, L.L.P., 3040 POST OAK BOULEVARD, SUITE 1500, HOUSTON, TX, 77056, US

(73) Assignee: Source, Inc.

(21) Appl. No.: 11/343,734

(22) Filed: Jan. 31, 2006

Related U.S. Application Data
(60) Provisional application No. 60/649,372, filed on Feb. 1, 2005.
(60) Provisional application No. 60/677,075, filed on May 3, 2005.

(51) Int. Cl. G07F 19/00; G06K 5/00; G06Q 40/00

(52) U.S. Cl. 235/379; 235/382; 705/44

(57) ABSTRACT

The system of the present invention comprises a personal Virtual Safety Deposit Box where users are able to enroll their identification methods, financial accounts and personal information. Once authenticated, this information is transferred to a master file within a central databank. Enrollment enables the user to link each item (collectively referred to as the “stored data”) to any one of the plurality of identification methods they enter. Thereafter, the user may employ their enrolled identification methods to select a desired one of the stored data fields. A secure intermediary uses the identification method and a selection method to determine which of the stored data fields the user desires to employ by accessing a database containing each of the stored data fields and the corresponding selection method. The selected field is activated and any relevant outside agencies are notified of the transaction and the transaction is concluded.

### CROSS-REFERENCE TO RELATED APPLICATIONS

This application claims benefit of U.S. provisional patent application Ser. No. 60/649,372, filed Feb. 1, 2005. This application also claims benefit of U.S. Provisional patent application Ser. No. 60/677,075, filed May 3, 2005. Each of the aforementioned related patent applications is herein incorporated by reference.

### BACKGROUND OF THE INVENTION

1. Field of the Invention

Embodiments of the present invention generally relate to a system and method relating to the electronic tracking of personal and financial information tied to a unique identification number in a central databank and the prevention of disclosure of that information to third parties during financial transactions and information transfers between parties to minimize the threat of identity theft or identity fraud.

Identity theft refers to the wrongful acquisition and use of an individual's personal data for personal gain and fraudulent criminal purposes. Personal data such as driver's license numbers, social security numbers, bank accounts, credit card numbers, medical information and other valuable personal and financial information can be stolen or discovered by an identity thief who can use this information to run up debts, commit fraud or crimes in the stolen identity. Some of the most difficult damage to repair can be to an individual's credit rating, legal standing and reputation, which may haunt the individual for years after an identity theft is discovered and stopped.

2. Description of the Related Art

Credit and debit cards are often used to facilitate Electronic Funds Transfers for commercial transactions. A credit card is any card or other like credit device, having an account number embossed on the surface that enables the holder to obtain money, property, labor or services (collectively referred to as “a purchase”) on credit. Identification of the purchaser is typically made by comparing their signature to the signature on the back of the card. When making a purchase, a person presents the card to a merchant who sends the account number to a financial institution to verify that the account is valid and whether the purchase will exceed the account's maximum credit limit. If the financial institution authorizes the purchase, an authorization code is transmitted to the merchant who may then conclude the transaction. Debit cards differ from credit cards primarily because debit cards are linked to a specific account owned by the customer and are not a credit transaction. Using the embossed account number on the card, the merchant instructs the financial institution to transfer funds from the purchaser's account at the time the purchase is made. Credit and debit cards are a convenient alternative to paying for a purchase instead of using a check or paying with cash. Most purchasers will often carry several credit and debit cards, together with their checkbook and a small amount of cash. With the widespread use of credit and debit cards has come an increase in credit card crime. Credit card crime occurs when a person uses a stolen or forged credit or debit card or the respective account numbers to obtain property or services. Stolen or lost checks are also improperly used to defraud merchants. Fraudulent use of credit cards, debit cards and checks is a serious problem for merchants and the financial industry.

To minimize loss from fraudulent use, merchants will often require the purchaser to sign a receipt so that signature on the receipt can be compared to the authorized user's signature which appears on the back of the card. This type of verification tends to minimize the use of stolen cards by an unauthorized person. Merchants also often provide a keypad for the purchaser to enter a personal identification number (PIN) to verify their identity, again in an effort to prevent unauthorized use. Notwithstanding these precautions, there is great need to minimize fraudulent use of credit cards, debit cards and checks.

With the popularity of the Internet, more and more credit and debit transactions are occurring for on-line purchases where the purchaser and the merchant never see or talk to the other. Because the buyer and the seller are remote from each other, it is difficult to verify that a remote buyer is authorized to use the card. Accordingly, there is a great need for a system that prevents the fraudulent use of credit and debit cards for Internet transactions.

Notwithstanding the safeguards implemented by the credit card industry, there is still a significant risk that a card number and the user's name may be stolen and used without the authority of the customer. In one common identity theft scheme, an employee of a merchant steals the identity of the customer and uses this identity to purchase product and services. Account information is readily obtained from stolen checks because it is often printed on the face of the instrument so it is relatively easy to forge the check signature and to create supporting fake identification cards. Once the identity theft has occurred, significant amount of fraudulent use may be incurred before the theft is discovered and corrective measures taken to prohibit further unauthorized use. It is an inherently poor scheme to rely on the detection of unauthorized use of credit cards, debit cards or checks because the theft may not be detected quickly. Cases of identity theft and fraud are on the rise across the country and governments, businesses and individuals are looking for ways they can safeguard their personal and financial information. Rather than rely on detection of the identity theft after it happens, a system and a method that prevents identity theft from occurring and does not burden either the customer or the merchant is needed.

Further, it is common for many merchants to participate in a customer loyalty program to reward loyal customers with discounts or other inducements to frequently purchase goods or services from the merchant. For example, many credit card issuers will award customers with airline frequent flier miles for each dollar charged to their card. Other credit cards will provide a cash refund for each purchase.

### SUMMARY OF THE INVENTION

The present invention generally relates to a system and method that electronically tracks and prevents disclosure of a customer's information, e.g., personal information, number identification and financial instruments. In one embodiment, tracking and preventing disclosure is done while maintaining the ease of using identification and financial instruments inputted into a user's personal database or Virtual Safety Deposit Box (“VSDB”) and then into a twin master file in a central data repository (referred to as the “Central Databank”).

In accordance with the present invention, a user is assigned or provided with a Unique Identification Number which identifies and differentiates that user within a Central Databank.

The user enters data into their unique VSDB, which is then uploaded into the user's master file within the Central Databank and attributed to the user's Unique Identification Number. In one embodiment of the present invention, the user logs into a website and then enters the data into their VSDB. In alternate embodiments this may be done through paper applications, phone, batch files, other data entry methods or through a combination of multiple data entry methods.

Stored Data may include methods of identification and multiple financial instruments or personal information. Methods of identification stored in the VSDB and Central Databank may include the user's driver's license number, social security number, biometrics templates, smart cards, radio frequency identification chips or cards, Global Positioning System (“GPS”) identification systems, cell phones, loyalty identification, memory chips carried by the user or implanted within the user's body, telematics, digital identity methods, bluetooth information or broker software. In one embodiment of the present invention, the unique identification number used within the present invention's Central Databank may itself be used as an identification method. As is well known in the art, biometrics templates used as identification methods may be derived from physical or behavioral traits such as cardiac pulse, dental radiograph, dental geometry, ear geometry, facial geometry or thermographs, fingerprints, gait, genetics, hand geometry, handwriting, iris, keystroke or mouse dynamics, palm prints, pores, retinal, skin spectrum, tapping, vascular pattern, visual skin, voice recognition or any other recordable physical or behavioral trait that has sufficient variation to serve to uniquely identify the user.

The Central Databank links the user's unique identification number to a plurality of financial instruments, including credit cards, debit cards, checking accounts, brokerage and bank accounts, governmental benefit accounts including salary, social security, medicare or welfare accounts, paper script accounts, electronic script accounts, loyalty accounts, frequent flyer accounts, stocks and bonds or other financial instruments which may be accessed by the user during a financial transaction. Thus, the VSDB can be the single source to organizing both financial information and other accounts that affect the welfare and personal commerce of an individual. With the information contained in a single data repository, management efficiency is improved because there is no need to carry or store a plurality of separate cards or pieces of paper. The user's VSDB functions as a backup to such paper documents.

Personal information which may be registered into the user's VSDB under the user's unique identification number may include any information chosen to be stored by the user, such as medical information, preferences in music, art, movies, media or other products, lifestyle information, purchasing history and other data.

In another embodiment of the present invention, additional stored data about the user may also be registered under the user's Unique Identification Number by outside agencies. This data may include credit reports, financial statements, criminal records, employment information or other information pertaining to the user.

In one embodiment of the present invention, all stored data is verified by an authentication center which is preferably a neutral agency that has no vested interest in the data being authenticated. This authentication center could be a government regulatory agency, a financial network, or any other similar agency or group of agencies capable of authenticating the stored data.

The user is provided with a method or methods for selecting between the stored data fields entered into the Central Databank (referred to collectively as “selection methods”). In one embodiment of the present invention, the user will register a unique Personal Identification Number (PIN) for each stored data field. In an alternate embodiment, one PIN may be used as a standard selection method for all stored data fields and the user may assign a short second identification tag to each stored data field, for example 123451 selects the first stored data field, 123452 selects the second stored data field, etc. In other embodiments, the identification method may also serve as the selection method. This may be accomplished by setting one stored data field as active and that field would be used until a different field was chosen, or one field might be linked to each method of identification and would always be used if that identification method were used, or other selection methods not yet conceived may be used to identify the information to be shown.

Once the above steps are completed, the user may employ the present invention to initiate anonymous financial transactions and a variety of information sharing services. The user provides the merchant or Third Party with an identification method previously entered into their VSDB. The exact process the user employs to transfer the identification method to the merchant will vary depending on the specifics of the identification method in question. The majority of identification methods employed in face to face transactions involve the use of a reader device to scan the user's card, biometrics feature, etc. In online transactions, online identity protocols are used. The user will also provide the merchant or Third Party with one of the selection methods described above unless the identification method also serves as the selection method.

The merchant or Third Party transfers the identification and selection methods to a secure intermediary which uses this information to determine the user's Unique Identification Number within the Central Databank and which stored data field the user has elected to use in that transaction.

In the case of financial transactions, the Identification Method and Selection method determine which Financial Account the user has elected to use. The secure intermediary then transfers the purchase information to the selected financial institution, that is the credit card issuer or the bank in the case of a debit card. The financial institution returns an authorization number to the intermediary who returns the authorization number to the merchant. Upon receipt, the merchant concludes the transaction but at no point in the transaction does the merchant have access to the customer's name, type of card accessed or the account number. Thus it is not possible for an unscrupulous employee to detect account or personal information.

In one embodiment of the present invention, the secure intermediary may perform several actions in regards to personal information stored in the Central Databank. The secure intermediary may transmit the selected stored data field to the Third Party. Alternatively, the secure intermediary may be sent data or a query from the Third Party at the request of either the secure intermediary or the Third Party. The secure intermediary would then use a system of internal protocols and a neutral data comparison system to securely compare the data or query from the Third Party and data from the selected stored data field. In one embodiment of the invention, if the two sets of data match within the parameters of the secure intermediary's protocols, the secure intermediary transmits a ‘pass’ to the Third Party. If the data does not match within the established parameters, the secure intermediary transmits a ‘fail’ to the Third Party.

In another embodiment, the selected data is compared to a range of data categories stored by the Third Party or by the secure intermediary. For example, the data categories may be a simple age test with categories of “twenty-one years of age and over” and “twenty years of age and below.” The data categories may also be very complex multi field categories that give a very precise picture of the user. Once the data categories are selected, the secure intermediary uses established protocols and a neutral data comparison system to select which of the relevant data categories best represents the user's selected data. The secure intermediary then transmits relevant data category to the Third Party. In alternate embodiments of the invention, some or all of these options may or may not be available.

One embodiment provides a method for storing a user's financial and personal information, the method comprising establishing a database having a master file, said master file containing the user's identification methods, personal information and a list of enrolled payment accounts, associating said master file with a unique identification number assigned to the user; and enabling the user to enter data into the master file under their unique identification number. In another embodiment, the data entry method is a website. In another embodiment, the data entry method is a paper form. In another embodiment, the data entry method is a telephone system. In another embodiment, the data entry method is a batch file. In another embodiment, the stored identification method is a driver's license number. In another embodiment, the stored identification method is a social security number. In another embodiment, the stored identification method is a driver's license number. In another embodiment, the stored identification method is a smart card. In another embodiment, the stored identification method is a radio frequency identification chip or card. In another embodiment, the stored identification method is a global positioning system identification system. In another embodiment, the identification method is a cell phone. In another embodiment, the stored identification method is a loyalty card or loyalty program identification number. In another embodiment, the stored identification method is a memory chip carried by the user or implanted in the user's body. In another embodiment, the stored identification method is a telematics system. In another embodiment, the stored identification method is a digital identity method. In another embodiment, the stored identification method is bluetooth information. In another embodiment, the stored identification method is derived from broker software. In another embodiment, the stored identification method is a biometrics template. In another embodiment, the biometrics template is derived from cardiac pulse. In another embodiment, the biometrics template is derived from dental radiographs. In another embodiment, the biometrics template is derived from dental geometry. In another embodiment, the biometrics template is derived from ear geometry. In another embodiment, the biometrics template is derived from facial geometry. In another embodiment, the biometrics template is derived from facial thermography. In another embodiment, the biometrics template is derived from fingerprint scans. In another embodiment, the biometrics template is derived from gait. In another embodiment, the said biometrics template is derived from genetics. In another embodiment, the biometrics template is derived from hand geometry. In another embodiment, the biometrics template is derived from handwriting. In another embodiment, the biometrics template is derived from iris scans. In another embodiment, the biometrics template is derived from keystroke or mouse dynamics. In another embodiment, the biometrics template is derived from palm prints. In another embodiment, the biometrics template is derived from pores scans. In another embodiment, the biometrics template is derived from retina scans. In another embodiment, the biometrics template is derived from skin spectrographs. In another embodiment, the biometrics template is derived from tapping. In another embodiment, the biometrics template is derived from vascular patterns. In another embodiment, the biometrics template is derived from visual skin scans. In another embodiment, the biometrics template is derived from voice recognition. In another embodiment, the personal information is the user's name, birthdate, or other identifying information. In another embodiment, the personal information is a survey of the user's preferences for music, art, products or services. In another embodiment, the personal information details the user's lifestyle or lifestage. In another embodiment, the personal information is registered by individuals or groups other than the user. In another embodiment, the payment account is a debit card account. In another embodiment, the payment account is a checking account In another embodiment, the payment account is a brokerage account. In another embodiment, the payment account is a loyalty account. In another embodiment, the payment account is a governmental benefits account including salary, social security, medicare or welfare account. In another embodiment, the payment account is a paper script account. In another embodiment, the payment account is an electronic script account. In another embodiment, the payment account is a frequent flyer account. In another embodiment, the step of enabling the user to select a specific stored data field from their master file at a third party location. In another embodiment, the system is used to prevent fraudulent acquisitions of an account holder's financial information during merchant initiated transactions, the method comprising the steps of, enrolling at least one identification method into the user's master file, enrolling at least one financial account into the user's master file with properly setup selection method, using the identification and selection methods to initiate a transaction at a merchant's point of sale terminal; transferring account information, obtained from said identification method and selection method, to a financial intermediary, determining the designated payment account; requesting the financial institution corresponding to said designated payment account to authorize the transaction; informing the merchant of authorization by said financial institution, and recording the transaction history in said master file. In another embodiment, the system is used for conducting financial transactions using one of a plurality of accounts selected by a user comprising the steps of, enrolling at least one identification method into the user's master file, enrolling at least one financial account into the user's master file with properly setup selection method, initiating a transaction request by communicating a request to transfer funds to a destination account, obtaining authorization to complete the transaction request from a financial intermediary associated with at least one financial account and completing the requested financial transaction by causing an electronic funds transfer from at least one account to a destination account; and recording the transaction history in said master file. In another embodiment, the step of receiving from an entity associated with said destination account, a rebate or discount to be credited to at least one financial account. In another embodiment, the steps of associating each enrolled account with a second entity and crediting an account of said second entity with a portion of the rebate or discount provided by said entity with a selected portion of said rebate or discount where said database maintains an association between said second entity and said financial account. In another embodiment, the system is used to allow the user to securely divulge specific stored data fields to a Third Party without giving said agency access to any other information about the user, the method comprising the steps of, enrolling at least one identification method into the user's master file, enrolling at least one data field of the user's personal information into the user's master file with properly setup selection method, using the identification and selection methods to initiate a data transfer at a third party location's terminal, transferring said stored data field of personal information, obtained from said identification method and selection method, to the Third Party, and recording the data transfer in said master file. In another embodiment, the system is used to allow the user to securely divulge specific stored data fields to a Third Party without giving said agency access to any other information about the user, the method comprising the steps of, enrolling at least one identification method into the user's master file, enrolling at least one data field of the user's personal information into the user's master file with properly setup selection method, using the identification and selection methods to initiate a data transfer at a third party location's terminal; transferring said stored data field of personal information, obtained from the user's master file by said identification method and selection method, to the Third Party, and recording the data transfer in said master file. In another embodiment, the system is used to allow a Third Party to classify user into one of a plurality of selected data categories without revealing other information about the user, the method comprising the steps of, enrolling at least one identification method into the user's master file, enrolling at least one data field of the user's personal information into the user's master file with properly setup selection method, using the identification and selection methods to initiate a data transfer at a third party location's terminal, enabling the Third Party to transmit a question or data query to the secure intermediary in the form of a plurality of categorizations of data, using said identification and selection methods to determine the relevant stored data field in the user's master file, using a neutral data comparison system to securely compare said stored data field from the user's master file to the categorizations of data provided by the Third Party to select which category of data the user's data best matches, transmitting said category of data which best matches the user's selected data to the Third Party, and recording the data transfer in said master file. In another embodiment, the system is used to allow a Third Party to classify user into one of a plurality of selected data categories without revealing other information about the user, the method comprising the steps of, enrolling at least one identification method into the user's master file, enrolling at least one data field of the user's personal information into the user's master file, using the identification method to initiate a data transfer at a third party location's terminal, enabling the Third Party to transmit a question or data query to the secure intermediary in the form of a plurality of categorizations of data, using a neutral data comparison system to securely compare the totality of data stored in the user's master file to the categorizations of data provided by the outside agency to select which category of data the user's data best matches, transmitting said category of data which best matches the user's master file to the Third Party, and recording the data transfer in said master file. In another embodiment, system is used to allow an Third Party to classify user into one of a plurality of selected data categories without revealing other information about the user, the method comprising, enrolling at least one identification method into the user's master file enrolling at least one data field of the user's personal information into the user's master file, enabling a Third Party that detects one or more of the user's registered identification methods to transmit said identification method to the secure intermediary without the direct participation of the user and using that identification method to determine the user's unique identification number in the database; enabling the Third Party to transmit a question or data query to the secure intermediary in the form of a plurality of categorizations of data, using a neutral data comparison system to securely compare the totality of data stored in the user's master file to the categorizations of data provided by the outside agency to select which category of data the user's data best matches, transmitting said category of data which best matches the user's master file to the Third Party, and recording the data transfer in said master file.

In yet another embodiment, the system for allowing a Third Party to review and authenticate all data stored in the user's master file is provided.

In yet another embodiment, the system is employed to allow the user to select which stored data field is to be transmitted to the merchant or Third Party. In another embodiment, the user selects a stored data field by entering one of a plurality of personal identification numbers to designate a corresponding one of said stored data fields. In another embodiment, the user selects a stored data field by entering one personal identification number as well as short second identification tag to designate a corresponding one of said stored data fields. In another embodiment, the user registers a specific stored data field to each of a plurality of identification methods and causes that stored data field to be accessed by the system at any time when that identification method is given. In another embodiment, the step of enabling the user to designate a stored data field for a future transaction using either an Internet or telephone connection.

In yet another embodiment, a system for tracking customer spending within a store premises comprises an identification mean capable of detecting and identifying the user without said user's active participation; a plurality of readers capable of detecting said identification means positioned within said store and a server computer coupled to said readers, for associating the identification method with a specific customer. In another embodiment, the system includes means for detecting purchases by each user at the location where the purchase decision is made. In another embodiment, the identification means is a contactless radio frequency identification device encoded with a unique identification number, said unique identification number capable of identifying the user. In another embodiment, the identification means is a global positioning system identification system capable of identifying the user. In another embodiment, the identification means is a biometrics template capable of being detected and identifying the user without said user's direct participation.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 illustrates the general design of the present invention.

FIG. 2 is a conceptual illustration of a preferred system of the setup procedures of the present invention.

FIG. 3 illustrates a preferred system for secure financial transactions in accordance with the present invention.

FIG. 4 illustrates another preferred system for secure financial transactions in accordance with the present invention.

FIG. 5 illustrates a preferred system for secure financial transactions in accordance with the present invention.

FIG. 6 illustrates a preferred system for completing financial transactions.

FIG. 7 illustrates another preferred system for secure personal information transactions in accordance with the present invention.

FIG. 8 is a block diagram of a system for identifying customers and detecting their location within the premises of a merchant.

### DETAILED DESCRIPTION

In the following description of the preferred embodiment, reference is made to the accompanying drawings that form a part hereof, and in which is shown by way of illustration specific embodiments in which the invention may be practiced. It is to be understood that other embodiments may be utilized and that changes may be made without departing from the scope of the present invention.

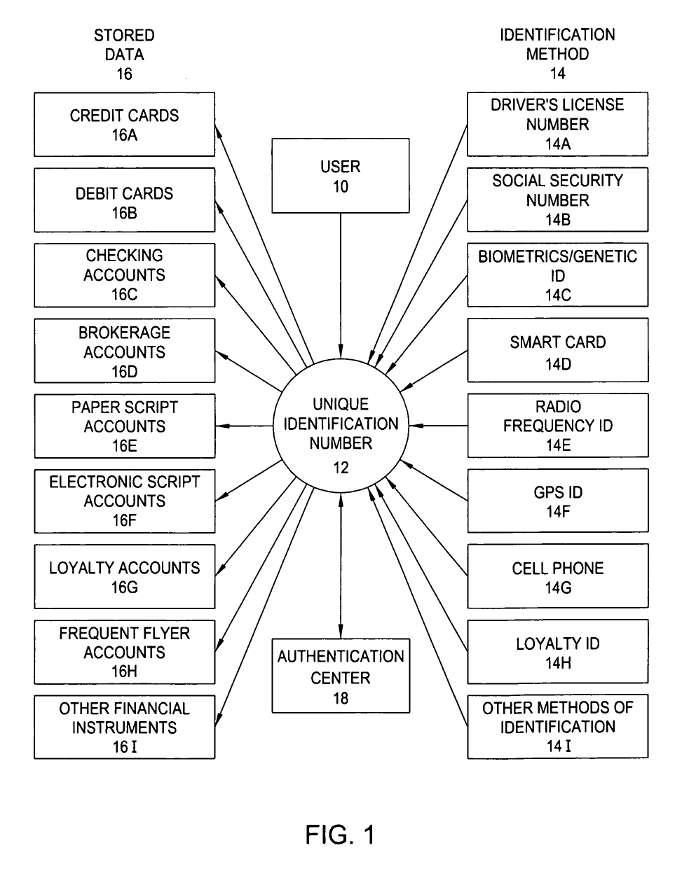

Referring now to FIG. 1, in its simplest embodiment, the present invention assigns User 10 a Unique Identification Number 12 and allows User to register Identification Methods 14 and Stored Data 16 to their Unique Identification Number. All Stored Data and Identification Methods are analyzed and authenticated by Authentication Center 18 as a safeguard to ensure the information registered by User is accurate.

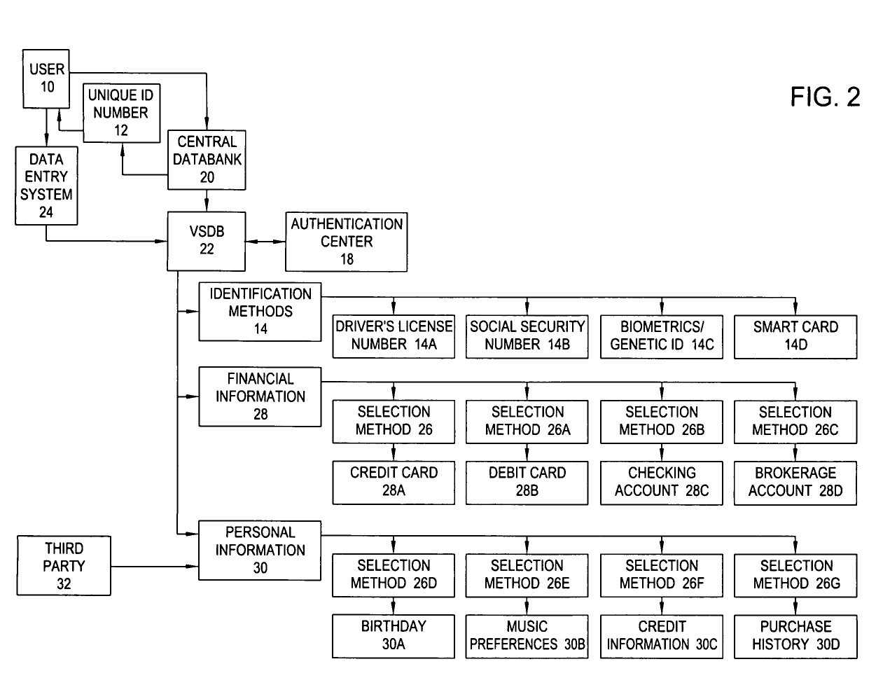

Referring now to FIG. 2, one architectural model of the user setup procedure of the present invention is shown. User 10 first contacts the organization maintaining Central Databank 20 and is assigned Unique Identification Number 12 which is the key form of identification the present invention uses to identify User 10. User 10 then utilizes Data Entry System 24 to register information into VSDB 22 under User 10's Unique Identification Number 12.

In one embodiment of the present invention, Data Entry System 24 takes the form of a central website which User 10 accesses to establish a secure, on-line account with access controlled by a user name and PIN. User 10 may enter identification methods, selection methods, financial information and personal information into their VSDB 22. This information is then checked for accuracy and authenticated by Authentication Center 18 and uploaded into a secure personal master file stored in Central Databank 20. User 10 enters personal information and lists all credit cards, debit cards, checking accounts and other payment accounts together with any expiration dates. User 10 may access and update their VSDB 22 at any time within the limitations of Data Entry System 24 but the true master file is stored in Central Databank 20 and is only accessible by the secure intermediary and Authentication Center 18.

Data Entry System 24 also provides the ability to control the functioning of VSDB 22, specifically to enable User 10 to change the selection method of any stored data field as desired or to specify one of the plurality of accounts stored in VSDB 22 to be used for User 10's next purchase. Data Entry System 24 may also be used to enter personal information to be configured as a profile or to check the account balance on each account. Preferably, Data Entry System 24 is an Internet connection but in alternate embodiments it may also be via telephone connections, paper applications, batch files, other data entry methods or a combination of multiple data entry methods. If telephone access is desired, User 10 is readily authenticated because their master file in Central Databank 20 maintains their customer profile comprising customer specific information. Using their master file profile in Central Databank 20, an employee of the intermediary institution presents a series of questions which only the user would know to validate the caller's identity. When the questions are properly answered, User 10 is granted the necessary privileges to change or modify the account. In one preferred embodiment, a credit reporting agency, such as TransUnion, Inc., uses its proprietary database to determine whether an unknown caller is User 10 or not. If the caller is unable to correctly answer the list of questions, the caller is denied access to information stored in VSDB 22.

Once registered, Identification Methods 14 may be used to anonymously identify User 10's Unique Identification Number within Central Databank 20 and access User's secure master file listing with relevant information stored in the database under that number broken down into identification methods, selection methods and stored data. Stored data includes personal and financial information. Identification and selection methods are stored in such a way that they may be flagged by searches used to determine the user's identity and which stored data field the user wishes to access.

The selection method utilized by the present invention may vary but in each embodiment User 10 is provided with a way to distinguish between the stored data contained in VSDB 22. Selection Method 26 may be embodied by a prompt that asks User 10 to assign a specific password to each stored data field as it is registered in VSDB 22. By way of example, if credit card “A” is associated with “password1”, each time User 10 enters “password1” as Selection Method 26, credit card “A” is selected for that transaction. In an alternate embodiment or as an add-on feature for financial transactions, User 10 may be prompted to assign each financial instrument or account a usage priority. Thus, User 10 may maintain approximately equal balances charged to each account or can designate a primary account for all charges up to a specified amount after which other accounts are made available.

In one embodiment of the present invention, Third Party 32 may also register information into User 10's VSDB 22 subject to the same review and authentication process by Authentication Center 18. This data may include credit reports, financial statements, criminal records, employment information or other information pertaining to the user.

Whether registered by User 10 or Third Party 32, all information stored in VSDB 22 is subject to authentication by Authentication Center 18, which is preferably a neutral third-party provider with no vested interested in the data in question. Authentication Center 18 may take the form of a government regulatory agency, a financial network, or any other similar agency or group of agencies capable of authenticating the stored data. Stored data will be authenticated upon registration with VSDB 22 and preferably on a recurring basis as needed and then entered into User 10's master file in Central Databank 20.

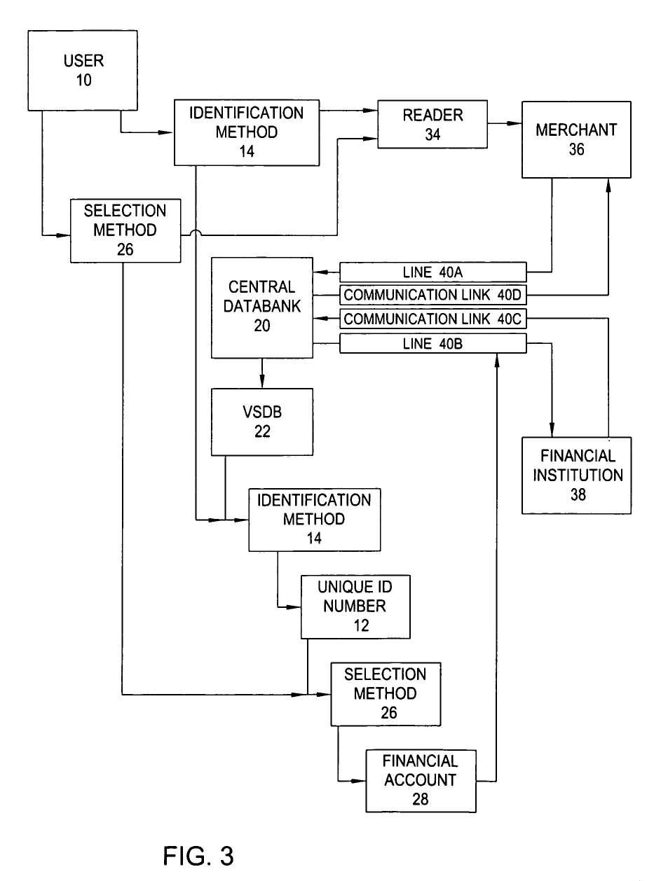

The invention's preferred system for secure financial transactions is illustrated in FIG. 3. Specifically, when User 10 presents identification method 14 and selection method 26 to merchant 36 via reader 34, the corresponding information is transmitted to Central Databank 20 as indicated by Line 40A. Preferably, the identification method is encrypted so that transmission from the merchant to the Central Databank is immune from detection. Central Databank 20 acts as a secure intermediary between the user and the merchant. Central Databank 20 compares Identification Method 14 to User 10's master file to determine User 10's Unique Identification Number 12 and therefore access User 10's secure master file. Then Central Databank 20 compares Selection Method 26 to each stored data field in the master file to determine which of the available accounts User 10 has selected, as indicated by Financial Account 28. Central Databank 20 then establishes a communication link, indicated by Line 40B, with Financial Institution 38 that services Financial Account 28. If, by way of example, Financial Account 28 is a checking account at a regional bank, the account information and transaction amount is electronically transferred to the bank for approval. Upon receipt of the banks authorization, sent by Communication Link 40C, Central Databank 20 transfers the authorization to merchant 36, as indicated by Communication Link 40D.

Advantageously, when the customer participates in a loyalty program the transaction amount and merchant information is retained in Central Databank 20. In this manner, the user is automatically rewarded for patronizing the merchant participating in the loyalty program. In some loyalty programs, a portion of the purchase amount is to be credited to the customer as an incentive to patronize the merchant in the future. For example, a three percent (3%) award is deducted from the transaction amount with a portion returned to an account owned by the customer (e.g. Financial Account 22 shown in FIG. 3). The award amount may then be applied to subsequent purchases once a specific amount of funds is collected or a specific amount of time has passed. In other loyalty programs, the customer may accumulate points based on the value of cumulative purchases from participating merchants. The accumulated points may from time to time be redeemed for goods or services from the participating merchants.

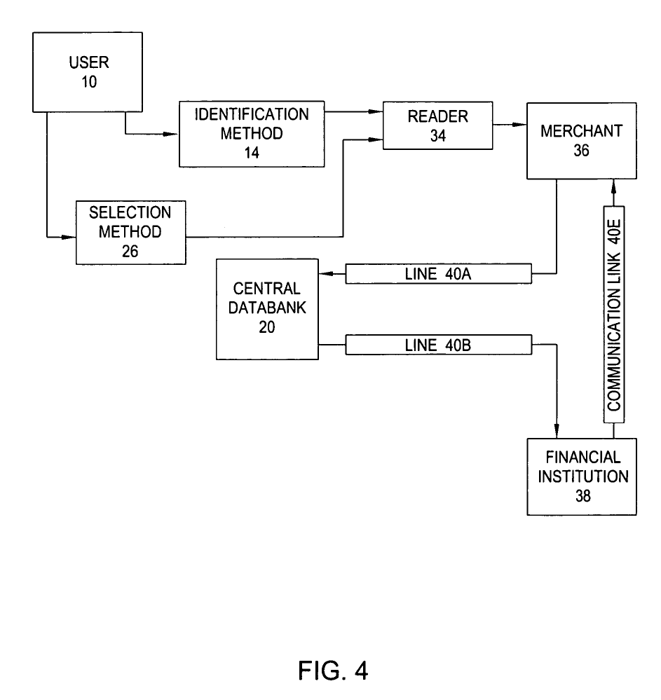

A similar architectural model of the present invention, similar to that shown in FIG. 3, is illustrated in FIG. 4. Merchant 36 initiates a transaction by sending information about Identification Method 14 and Selection Method 26 to Central Databank 20 by Line 40A. Preferably, the identification method is encrypted so that transmission from the merchant to the Central Databank is immune from detection. The Identification Method in combination with the Selection Method determines which account is to be accessed. In turn, Central Databank 20 forwards the account number of the selected credit card, debit card or other payment account to the corresponding Financial Institution 38 together with the amount of the transaction via Line 40B. In this embodiment, however, Financial Institution 38 transmits the authorization directly to merchant 36 via communication link 40E. It will be appreciated by one skilled in the art that a split dialer, such as is known in the art, may be essential for accessing the Central Databank 20 as well as simultaneously establishing a communication link between merchant 36 and financial institution 38.

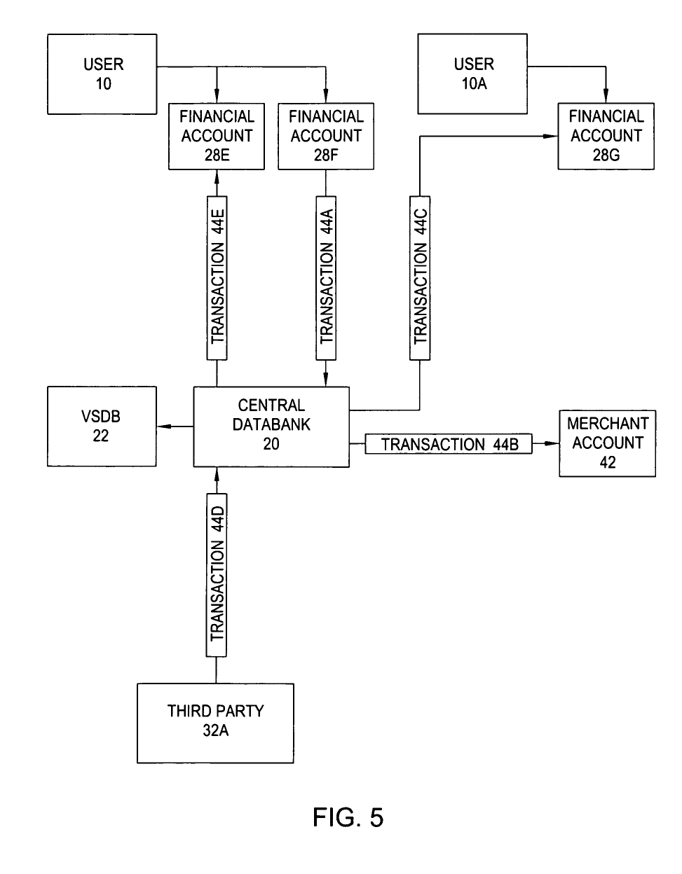

Referring now to FIG. 5, another embodiment of the present invention is illustrated. Once User 10 links one or more of their accounts as Financial Account 28F to VSDB 22, financial transactions are implemented using Electronic Funds Transfers between one of the user's selected accounts and a destination account. In FIG. 5, the financial structure for two users is illustrated as User 10 and User 10A. Each user may update their account by accessing their VSDB 22. When a user desires to transfer funds, a transaction request is initiated by either using a Point of Sale terminal or over the Internet. This is not intended to limit the manner in which a user may initiate a transaction. The only requirement is that the Identification Method be transmitted to the Central Databank 20 together with a Selection Method. By way of example, when User 10 desires to transfer funds to two accounts, the transaction request is transferred to Central Databank 20 where the selected account is debited. In FIG. 5, Financial Account 28F is linked to User 10's Unique Identification Number and is the designated account for Transaction 44A. Central Databank 20 is updated to reflect the debited amount and, after the financial institution owning the account authorizes the transfer, the funds are credited to the destination Merchant Account 42 as indicated by Transaction 44B and to Financial Account 28G as indicated by Transaction 44C. Financial Account 28G is linked to user 10A's Unique Identification Number. Since there is no need to exchange account numbers, User 10 and User 10A do not need to exchange account numbers for the debited or credited accounts. Accordingly, the registered financial accounts minimize improper use of the account by individuals receiving the payment.

Since the transaction is not limited to a credit card or debit card transaction, it is further possible to transfer cash from one account to the account of a third party. Thus, auction transactions may be safely transacted without disclosing account numbers to the seller. Where the funds transfer is to a merchant, such as Transaction 44B, the merchant may award loyalty points to the account of User 10 by notifying Central Databank 20. If the merchant associated with Merchant Account 42 desires to link their loyalty program with other merchants, the record-keeping burden is minimized because the merchant does not need to maintain the multiple-merchant loyalty account.

The present invention simplifies the receipt of funds as well. As illustrated by Transaction 44E, a Third Party 32A initiates a Transaction 44D that transfers funds using Electronic Funds Transfers to a user designated account, such as Financial Account 28E as indicated by transaction Transaction 44E. By way of example, federal, state and local governments may transfers benefit payments to selected users. However, since the users' account information is not available to the payor, privacy and fraud protection is increased.

For each transaction, Central Databank 20 records the transaction details in the User's master file in Central Databank 20 and their VSDB 22. User 10 may view their VSDB 22 in order to obtain a complete financial overview of all account activity. Since merchants, individual users and the government report transactions to Central Databank 20, a substantial amount of private information will be collected. However, the user is able to control their account by selectively configuring their VSDB 22 to allow merchants to forward special offers, rebates or discounts to them or to block such offers.

As explained herein, the present invention links all of a user's accounts with a Unique Identification Number. User 10 may access their VSDB 22 to configure the accounts to initiate or receive payments without disclosing account numbers to third parties. Merchants may manage their customer accounts without undue overhead and may increase revenue by encouraging repeat purchasers by selectively targeting rebates or discounts to their best customers. For the user, privacy, fraud protection and convenience are increased for both in-store purchases and financial transactions conducted over the telephone or Internet.

In accordance with another aspect of the present invention, management of both the customers and the merchant relationships is greatly improved. The customer-merchant relationship is improved by linking all purchases at participating merchants to a single loyalty system. Each transaction accumulates loyalty rewards points with a single card rather than multiple individual loyalty cards. The customer can reduce the number of cards they must carry and maintain. They may select the account to use to conclude the transaction by transferring funds from any one of their accounts to the selected merchant or to other individuals. VSDB 22 facilitates the buying, selling, trading or shopping of the user.

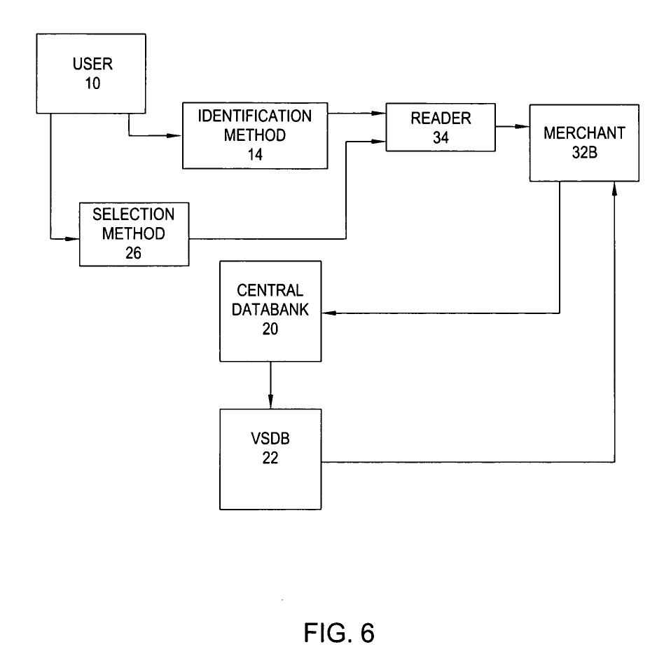

Referring now to FIG. 6, one embodiment of the present invention's preferred system for secure personal information transactions is shown. Specifically, User 10 initiates the transfer of personal information by presenting Identification Method 14 and Selection Method 26 to Third Party 32B, which may be a merchant, a government organization, an organization or other similar groups that has an interest in receiving User 10's personal information. Third Party 32B then transmits the relevant information to Central Databank 20. Central Databank 20 uses the Identification Method and Selection Method to determine which stored data field is to be accessed from the user's master file. In this embodiment, Central Databank 20 then forwards the information stored in the selected data field directly to the Third Party. The form of data transmission used by the present invention may vary depending on the nature and size of the data to be sent.

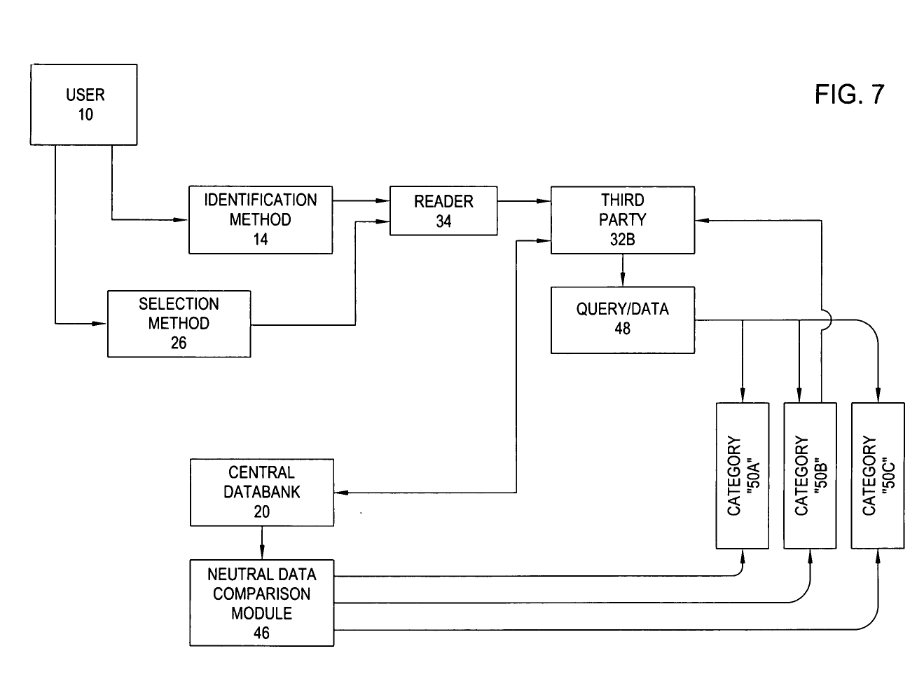

FIG. 7 illustrates another embodiment of the present invention's system for secure personal information transactions. User 10 initiates the transfer of personal information by presenting Identification Method 14 and Selection Method 26 to Third Party 32B. Third Party 32B then transmits the relevant information to Central Databank 20. In this embodiment, Third Party 32B also transmits its own data along with the Identification and Selection Method. This data may take the form of actual data, such as an access list of names. Alternatively, it may be in the form of a question or data query, such as ‘Is user 2 twenty-one years of age or older?’ This data may be sent at the request of Central Databank 20 or of Third Party 32B. Central Databank 20 uses the identification method and selection method to determine which stored data field is to be accessed from the user's master file.

The data from Third Party 32B and the user's data from their master file in Central Databank 20 are entered into Neutral Data Comparison Module 46 which uses a system of internal protocols to evaluate both sets of data. The data sent by Third Party 32B informs the Data Comparison Module to select certain data categories, represented by Category 50A, Category 50B and Category 50C, and evaluate which category the user's data matches. For example, if Third Party 32B sought to verify whether User 10 was of a certain age, Category 50A would represent age of twenty or lower, Category 50B would represent age twenty-one or higher, and Category 50C would represent an incompatibility of the data sets if User 10 submitted an incorrect data field for comparison. In this example, if the data submitted by User 10 proved the user was 25 years of age, a match to category 50B would then be transmitted back to Third Party 32B. In one embodiment of the present invention, the categories used are transmitted to Central Database 20 by Third Party 32B. In an alternate embodiment, the information on the categories to be used are stored in Central Database 20. Third Party 32B then transmits a message informing Central Database 20 of which data categories to use for the comparison. It is to be understood that Neutral Data Comparison Module 46 is not limited in the number of categories used for data comparison but rather Categories 50A, 50B and 50C are merely listed to illustrate the Data Comparison Module's versatility and function.

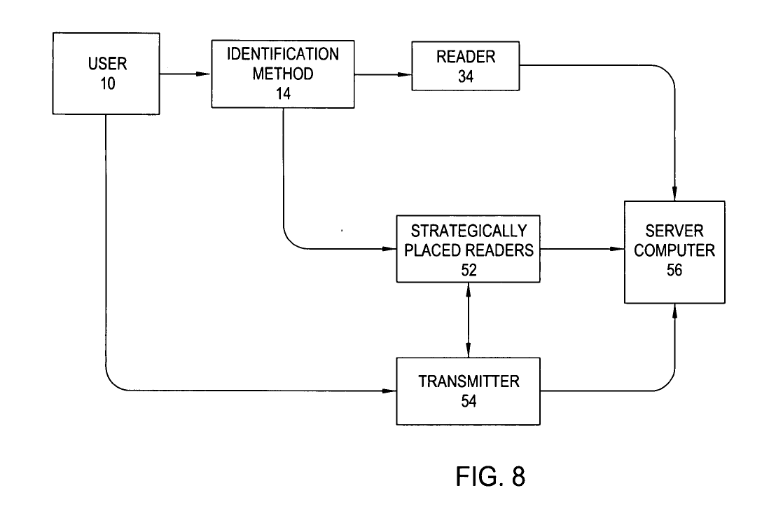

The present invention also includes ways for merchants and outside agencies to passively accumulate information about the user in ways that the user can control. In one embodiment illustrated in FIG. 8, User 10 registers upon entering the merchant's establishment. Registration is accomplished by Reader 34 reading the Identification Method 14 that User 10 provides upon entering the store. Identification method 14 may require the user to actively interact with Reader 34, such as with a magnetically encoded strip or fingerprint biometrics. Identification method 14 may also allow the reader to passively identify User 10 through methods such as RFID circuitry, GPS positioning, proximity cards or some biometrics techniques such as face or gait recognition, as are well known in the art. If this is the case, registration may occur as User 10 passes by a reader positioned proximate to the entry.

Thereafter, as the user traverses the stores, strategically placed readers 34 are set up to also detect Identification Method 14 through the previously described passive identification. Users may be provided with a Transmitter 54 that provides continuous tracking of User 10 location throughout the establishment for this purpose. Each Transmitter 54 includes a radio transmitter and a global positioning system (“GPS”) circuit for transmitting the customer's location in real time. The transmitter may preferably use either Bluetooth or WiFi wireless transmissions protocols. Thus, the merchant may track where the user spends the most time and track heavily trafficked areas in the establishment so that suppliers of goods can be charged a premium of positioning a display of products in such areas.

Each product is optionally provided with an RFID tag that is scanned by Transmitter 54 and the data transferred by way of a local network to a Server Computer 56. When the user acquires a product, the pen detects the RFID tag and transmits the name of the product to Server Computer 56. At the server, the product price is added to the user's electronic shopping card. When the user returns Transmitter 54 or leaves the premises, the contents in the electronic shopping cart are tallied and automatically transferred from the user's designated account and credited to the merchants.

If Identification Method 14 is a contactless smart card or proximity card, information about User 10 may be stored directly on the card allowing merchants to receive information from the user in real time. Thus, the merchant can greet the customer by name and can easily identify when a valued customer has entered the premises.

In another preferred embodiment, the merchant may passively read the Identification Method 14 from the user and query Central Databank 20 without use of a Selection Method by the user to determine which particular data fields to examine in Neutral Data Comparison Module 46. In this way, the merchant may passively receive information about the user in a variety of forms, either through direct transmission of data or through analysis and categorization of the user based on data categories submitted by the merchant. With the data collected by the server computer, merchants are better able to manage their assets. Particularly, the merchant builds a contact database that contains names of each customer, the preferred method of payment, the type of product or service the customer prefers. Each merchant may select customers from among their customer database to receive promotional or sales items. Merchants may also provide real time discounts to valued customers who frequent the establishment or who purchase a particular amount of goods or services.

While the foregoing is directed to embodiments of the present invention, other and further embodiments of the invention may be devised without departing from the basic scope thereof.

What is claimed is:

1. A system for storing a user's financial and personal information, the method comprising:
establishing a database having a master file, said master file containing the user's identification methods, personal information and a list of enrolled payment accounts;
associating said master file with a unique identification number assigned to the user; and
enabling the user to enter data into the master file under their unique identification number.

2. The method of claim 1 wherein said data entry method is a website.

3. The method of claim 1 wherein said data entry method is a paper form.

4. The method of claim 1 wherein said data entry method is a telephone system.

5. The method of claim 1 wherein said data entry method is a batch file.

6. The method of claim 1 wherein said stored identification method is a driver's license number.

7. The method of claim 1 wherein said stored identification method is a social security number.

8. The method of claim 1 wherein said stored identification method is a driver's license number.

9. The method of claim 1 wherein said stored identification method is a smart card.

10. The method of claim 1 wherein said stored identification method is a radio frequency identification chip or card.

11. The method of claim 1 wherein said stored identification method is a global positioning system identification system.

12. The method of claim 1 wherein said stored identification method is a cell phone.

13. The method of claim 1 wherein said stored identification method is a loyalty card or loyalty program identification number.

14. The method of claim 1 wherein said stored identification method is a memory chip carried by the user or implanted in the user's body.

15. The method of claim 1 wherein said stored identification method is a telematics system.

16. The method of claim 1 wherein said stored identification method is a digital identity method.

17. The method of claim 1 wherein said stored identification method is bluetooth information.

18. The method of claim 1 wherein said stored identification method is derived from broker software.

19. The method of claim 1 wherein said stored identification method is a biometrics template.

20. The method of claim 19 wherein said biometrics template is derived from cardiac pulse.

21. The method of claim 19 wherein said biometrics template is derived from dental radiographs.

22. The method of claim 19 wherein said biometrics template is derived 2 from dental geometry.

23. The method of claim 19 wherein said biometrics template is derived from ear geometry.

24. The method of claim 19 wherein said biometrics template is derived from facial geometry.

25. The method of claim 19 wherein said biometrics template is derived from facial thermography.

26. The method of claim 19 wherein said biometrics template is derived from fingerprint scans.

27. The method of claim 19 wherein said biometrics template is derived from gait.

28. The method of claim 19 wherein said biometrics template is derived from genetics.

29. The method of claim 19 wherein said biometrics template is derived from hand geometry.

30. The method of claim 19 wherein said biometrics template is derived from handwriting.

31. The method of claim 19 wherein said biometrics template is derived from iris scans.

32. The method of claim 19 wherein said biometrics template is derived from keystroke or mouse dynamics.

33. The method of claim 19 wherein said biometrics template is derived from palm prints.

34. The method of claim 19 wherein said biometrics template is derived from pores scans.

35. The method of claim 19 wherein said biometrics template is derived from retina scans.

36. The method of claim 19 wherein said biometrics template is derived from skin spectrographs.

37. The method of claim 19 wherein said biometrics template is derived from tapping.

38. The method of claim 19 wherein said biometrics template is derived from vascular patterns.

39. The method of claim 19 wherein said biometrics template is derived from visual skin scans.

40. The method of claim 19 wherein said biometrics template is derived from voice recognition.

41. The method of claim 1 wherein said personal information is the user's name, birthdate, or other identifying information.

42. The method of claim 1 wherein said personal information is a survey of the user's preferences for music, art, products or services.

43. The method of claim 1 wherein said personal information details the user's lifestyle or lifestage.

44. The method of claim 1 wherein said personal information is registered by individuals or groups other than the user.

45. The system for a Third Party to review and authenticate all data stored in the user's master file.

46. The method of claim 1 wherein said payment account is a debit card account.

47. The method of claim 1 wherein said payment account is a checking account.

48. The method of claim 1 wherein said payment account is a brokerage account.

49. The method of claim 1 wherein said payment account is a loyalty account.

50. The method of claim 1 wherein said payment account is a governmental benefits account including salary, social security, medicare or welfare account.

51. The method of claim 1 wherein said payment account is a paper script account.

52. The method of claim 1 wherein said payment account is an electronic script account.

53. The method of claim 1 wherein said payment account is a frequent flyer account.

54. The method of claim 1, further comprising the step of enabling the user to select a specific stored data field from their master file at a third party location.

55. The system employed to allow the user to select which stored data field is to be transmitted to the merchant or Third Party.

56. The method of claim 55 wherein the user selects a stored data field by entering one of a plurality of personal identification numbers to designate a corresponding one of said stored data fields.

57. The method of claim 55 wherein the user selects a stored data field by entering one personal identification number as well as short second identification tag to designate a corresponding one of said stored data fields.

58. The method of claim 55 wherein the user registers a specific stored data field to each of a plurality of identification methods and causes that stored data field to be accessed by the system at any time when that identification method is given.

59. The method of claim 55 further comprising the step of enabling the user to designate a stored data field for a future transaction using either an Internet or telephone connection.

60. The method of claim 1 wherein said system is used to prevent fraudulent acquisitions of an account holder's financial information during merchant initiated transactions, the method comprising the steps of:
enrolling at least one identification method into the user's master file;
enrolling at least one financial account into the user's master file with properly setup selection method;
using the identification and selection methods to initiate a transaction at a merchant's point of sale terminal;
transferring account information, obtained from said identification method and selection method, to a financial intermediary;
Determining the designated payment account;
requesting the financial institution corresponding to said designated payment account to authorize the transaction;
informing the merchant of authorization by said financial institution; and
recording the transaction history in said master file.

61. The method of claim 1 wherein said system is used for conducting financial transactions using one of a plurality of accounts selected by a user comprising the steps of:
enrolling at least one identification method into the user's master file;
enrolling at least one financial account into the user's master file with properly setup selection method;
initiating a transaction request by communicating a request to transfer funds to a destination account;
obtaining authorization to complete the transaction request from a financial intermediary associated with at least one financial account and completing the requested financial transaction by causing an electronic funds transfer from at least one account to a destination account; and
recording the transaction history in said master file.

62. The method of claim 61 further comprising the step of receiving from an entity associated with said destination account, a rebate or discount to be credited to at least one financial account.

63. The method of claim 62 further comprising the steps of associating each enrolled account with a second entity; and
crediting an account of said second entity with a portion of the rebate or discount provided by said entity with a selected portion of said rebate or discount where said database maintains an association between said second entity and said financial account.

64. The method of claim 1 wherein said system is used to allow the user to securely divulge specific stored data fields to a Third Party without giving said agency access to any other information about the user, the method comprising the steps of:
enrolling at least one identification method into the user's master file;
enrolling at least one data field of the user's personal information into the user's master file with properly setup selection method;
using the identification and selection methods to initiate a data transfer at a third party location's terminal;
transferring said stored data field of personal information, obtained from said identification method and selection method, to the Third Party; and
recording the data transfer in said master file.

65. The method of claim 1 wherein said system is used to allow the user to securely divulge specific stored data fields to a Third Party without giving said agency access to any other information about the user, the method comprising the steps of:
enrolling at least one identification method into the user's master file;
enrolling at least one data field of the user's personal information into the user's master file with properly setup selection method;
using the identification and selection methods to initiate a data transfer at a third party location's terminal;
transferring said stored data field of personal information, obtained from the user's master file by said identification method and selection method, to the Third Party; and
recording the data transfer in said master file.

66. The method of claim 1 wherein said system is used to allow an Third Party to classify user into one of a plurality of selected data categories without revealing other information about the user, the method comprising the steps of:
enrolling at least one identification method into the user's master file;
enrolling at least one data field of the user's personal information into the user's master file with properly setup selection method;
using the identification and selection methods to initiate a data transfer at a third party location's terminal;
enabling the Third Party to transmit a question or data query to the secure intermediary in the form of a plurality of categorizations of data;
using said identification and selection methods to determine the relevant stored data field in the user's master file;
using a neutral data comparison system to securely compare said stored data field from the user's master file to the categorizations of data provided by the Third Party to select which category of data the user's data best matches;
transmitting said category of data which best matches the user's selected data to the Third Party; and
recording the data transfer in said master file.

67. The method of claim 1 wherein said system is used to allow an Third Party to classify user into one of a plurality of selected data categories without revealing other information about the user, the method comprising the steps of:
enrolling at least one identification method into the user's master file;
enrolling at least one data field of the user's personal information into the user's master file;
using the identification method to initiate a data transfer at a third party location's terminal;
enabling the Third Party to transmit a question or data query to the secure intermediary in the form of a plurality of categorizations of data;
using a neutral data comparison system to securely compare the totality of data stored in the user's master file to the categorizations of data provided by the outside agency to select which category of data the user's data best matches;
transmitting said category of data which best matches the user's master file to the Third Party; and
recording the data transfer in said master file.

68. The method of claim 1 wherein said system is used to allow an Third Party to classify user into one of a plurality of selected data categories without revealing other information about the user, the method comprising:
enrolling at least one identification method into the user's master file;
enrolling at least one data field of the user's personal information into the user's master file;
enabling a Third Party that detects one or more of the user's registered identification methods to transmit said identification method to the secure intermediary without the direct participation of the user and using that identification method to determine the user's unique identification number in the database;
enabling the Third Party to transmit a question or data query to the secure intermediary in the form of a plurality of categorizations of data;
using a neutral data comparison system to securely compare the totality of data stored in the user's master file to the categorizations of data provided by the outside agency to select which category of data the user's data best matches;
transmitting said category of data which best matches the user's master file to the Third Party; and
recording the data transfer in said master file.

69. A system for tracking customer spending within a store premises comprising an identification method capable of being detected and identifying the user without said user's active participation; a plurality of readers capable of detecting said identification methods positioned within said store and a server computer coupled to said readers, for associating the identification method with a specific customer.

70. The system of claim 69 further comprising means for detecting purchases by each user at the location where the purchase decision is made.

71. The method of claim 69 wherein said identification method is a contactless radio frequency identification device encoded with a unique identification number, said unique identification number capable of identifying the user.

72. The method of claim 69 wherein said identification method is a global positioning system identification system capable of identifying the user.

73. The method of claim 69 wherein said identification method is a biometrics template capable of being detected and identifying the user without said user's direct participation.
